(19) United States
(12) Patent Application Publication
(10) Pub. No.: US 2010/0209246 A1
(43) Pub. Date: Aug. 19, 2010

(54) YAW CONTROLLER FOR DOWNWIND WIND TURBINES

(76) Inventor: Robert Migliori, Newberg, OR (US)

Correspondence Address: Adrian IPLAW, LLC, 6107 SW Murray BLVD #404, Beaverton, OR, 97008, US

(21) Appl. No.: 12/703,760

(22) Filed: Feb. 10, 2010

Related U.S. Application Data
(60) Provisional application No. 61/152,526, filed on Feb. 13, 2009.

(51) Int. Cl. F03D 7/04

(52) U.S. Cl. 416/1; 416/32

(57) ABSTRACT

Apparatuses and methods are disclosed for the wind turbine yaw control. A wind turbine bedplate is rotateably mounted on a stationary tower. The bedplate is connected to a yaw encoder, which provides angular position of the bedplate with respect to the stationary tower. A wind vane, which can be attached to the bedplate, is connected to a wind vane encoder. The yaw encoder and wind vane encoder send data to a turbine controller. When the bedplate orientation differs from the average wind direction by a predetermined amount, a yaw brake that keeps the bedplate in place is released in a controllable fashion, such that some amount of friction between the brake pads and the stationary disk remains. Consequently, the bedplate will controllably rotate to align itself with the newly established average wind vector, thus aligning the turbine blade rotation plane substantially perpendicularly against the average wind vector. When the bedplate arrives to its new position, as determined by the yaw encoder reading, the yaw brake can be fully applied again to fix the bedplate at its new position.

### BACKGROUND OF THE INVENTION

This application claims priority to the provisional U.S. Patent Applications No. 61/152,526, filed Feb. 13, 2009, which is incorporated herein by reference in its entirety.

The present invention relates generally to wind turbines. More particularly, the present invention relates to the yaw angle adjustment systems and methods. These systems and methods adjust the turbine yaw angle with respect to the incoming wind in order to optimize power production by the turbine.

Due to the concerns over global warming and limited amount of fossil fuels, alternative methods of energy production are desired. One such alternative source of energy is the wind energy produced by wind turbines, which convert kinetic energy of the wind into electricity. The performance of a wind turbine is determined by many factors: size of the turbine blades, wind speed, type of the turbine (upwind or downwind), electrical generator's converting efficiency, and the orientation of the turbine blade rotation plane (i.e. the plane defined by the rotation of the turbine blades) relative to the angle of the wind. This angle between the turbine blade rotation plane and the incoming wind is called a yaw angle of the turbine. It is desirable to orient the turbine such that the wind direction is perpendicular to the turbine blade rotation plane, because this orientation maximizes the energy extraction from the wind. If allowed to pivot, a downwind turbine will orient itself such that the incoming wind blows roughly into the plane of rotation of the turbine blades. However, wind shear causes the blades to sense different wind speeds, thus producing unbalanced aerodynamic forces on the blades, which can result in a net torque about the tower axis. These effects are most pronounced when the wind flow is turbulent causing the turbine to “walk” or “fishtail” around the tower and turn itself out of the wind. A free yawing machine is also subject to high yaw rates which can damage turbine blades.

A variety of techniques for adjusting yaw angle exist in the field. Some upwind wind turbines use yaw brake and yaw motor, both of which are controlled to allow the wind turbine to follow the direction of wind. If the power fails, these turbines rotate to a downwind position, and the blade rotation is prevented. Furthermore, when in the downwind position, the rotating nacelle (or the bedplate that carries the nacelle) is not fixed with respect to the tower. Instead, the nacelle can be freely moved by the wind, causing so called “fishtailing” of the nacelle. Those techniques are based on the expensive and potentially unreliable motorized nacelle positioning against the incoming wind.

Some other wind turbines use a yaw damper system to reduce the fishtailing of nacelle. Those yaw dampers are based on oil viscosity or plate friction effects. The damping mechanisms typically have two or more parallel disks, where one disk rotates relative to other disk(s). However, these yaw dampers are passive elements, having no ability to make wind direction measurements or decisions as to the ultimate choice of the yaw angle. They will slow down, but not prevent the fishtailing.

Some other wind turbines disclose a yaw arresting mechanisms based on a locking toothed wheel (pawl) or a pinion type yaw locking device. However, those mechanisms are prone to failures and furthermore have only a limited number of possible yaw angles.

Therefore, a need remains for systems and methods that can adjust the yaw angle of the turbine, thus maximizing the turbine's output at different wind speeds and directions, while avoiding the undesirable fishtailing.

### BRIEF SUMMARY OF THE INVENTION

The present invention relates to systems for wind turbine yaw control. A wind turbine bedplate is rotateably mounted on a stationary tower. The bedplate is connected to a yaw encoder, which provides angular position of the bedplate with respect to the stationary tower. A wind vane, which can be attached to the bedplate, is connected to a wind vane encoder. The yaw encoder and wind vane encoder send data to a turbine controller. When the bedplate orientation differs from the average wind direction by a predetermined amount, a yaw brake that keeps the bedplate in place is released in a controllable fashion, such that some amount of friction between the brake pads and the, stationary disc remains. Consequently, the bedplate will controllably rotate to align itself with the newly established average wind vector, thus aligning the turbine blade rotation plane substantially perpendicularly against the average wind vector. When the bedplate arrives to its new position, as determined by the yaw encoder reading, the yaw brake can be fully applied again to fix the bedplate at its new position.

In one embodiment, an apparatus for controlling the orientation of a wind turbine, has: a stationary brake disc; a yaw brake attached with a bedplate of the wind turbine, whereas the yaw brake is capable of frictionally engaging the stationary brake disc in response to a control signal thus fixing a position of the bedplate with respect to the stationary brake disc; a wind vane capable of indicating a wind direction; a wind vane encoder attached with the wind vane and configured to indicate a rotational position of the wind vane, thus indicating the wind direction; a yaw encoder configured to indicate a rotational position of the bedplate with respect to the brake disc, thus indicating orientation of a turbine blade rotation plane with respect to the stationary brake disc; and a turbine controller capable of receiving information from the wind vane direction sensor and the yaw sensor, whereas the turbine controller is configured to: calculate a relative difference between the rotational positions of the wind vane and the bedplate, and generate a brake control signal, thus causing the yaw brake to engage and disengage.

In one aspect, the wind vane is attached with the bedplate.

In another aspect, the apparatus has a wind vane home position sensor configured to provide a home position of the wind vane with respect to the bedplate or the stationary brake disc.

In yet another aspect, the apparatus has a yaw home position sensor configured to provide a home position of the bedplate with respect to the stationary brake disc.

In another aspect, a brake control signal is generated to release the yaw brake when the relative difference between the rotational positions of the wind vane and the bedplate is higher than about +/−10°.

In another aspect, the apparatus has an anemometer configured to send a wind speed signal to the turbine controller, wherein the brake control signal is based at least in part on the wind speed signal, thus preventing unsafe yaw brake release at high wind.

In another embodiment, method for controlling the orientation of a wind turbine has the steps of:
receiving a wind direction data based on a wind vane position;
receiving a bedplate orientation data with respect to a stationary brake disc;
determining whether a difference between the bedplate orientation and the wind direction is higher than a threshold;
releasing a yaw brake that holds the bedplate fixedly with the stationary brake disc, thus enabling the bedplate to change its position with respect to the stationary brake disc; and
applying the yaw brake when the bedplate and the wind direction is lower than a threshold.

In one aspect, the releasing of the yaw brake is done at least in part based on a wind speed signal, thus preventing unsafe yaw brake release at high wind.

In another aspect, the releasing of the yaw brake is done such that the yaw brake slows down bedplate rotation at high wind.

In yet another aspect, the releasing of the yaw brake is done at least in part based on a pressure transducer signal.

In one aspect, the applying the yaw brake is done if the bedplate orientation and the wind direction substantially coincide.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 shows an exploded schematic view illustrating a wind turbine for generating electricity.

FIG. 2 shows an elevation cross-sectional view illustrating part of a yaw control mechanism in accordance with one embodiment of the present invention.

FIG. 3 shows a cross-sectional view of wind vane and wind vane encoding in accordance with one embodiment of the invention.

FIG. 4 is a flow diagram illustrating the steps of the yaw angle control method in accordance with one embodiment of the invention.

### DETAILED DESCRIPTION OF THE INVENTION

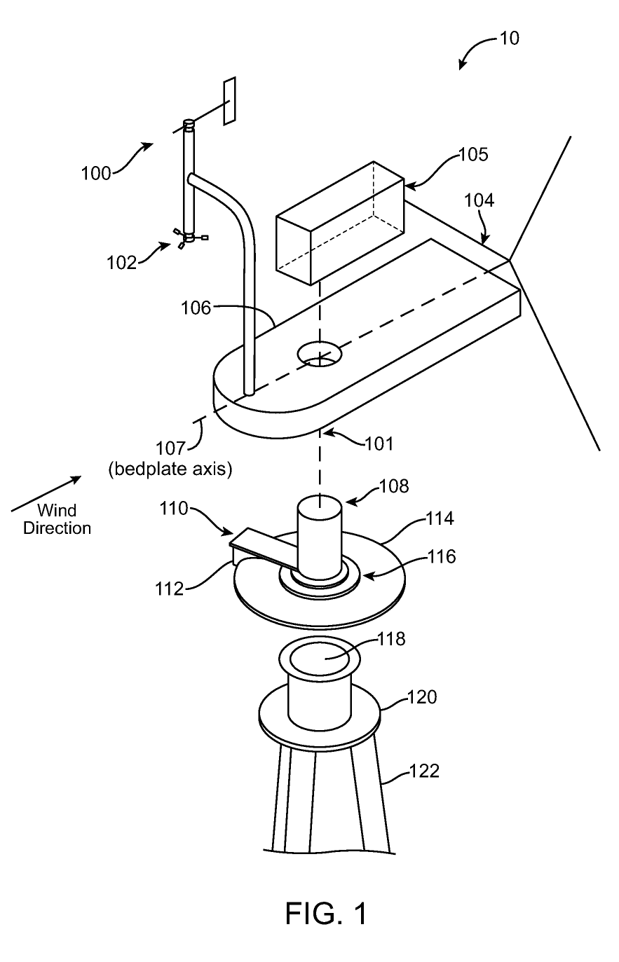

The present invention relates to systems for wind turbine yaw control. A wind turbine bedplate is rotateably mounted on a stationary tower. The bedplate is connected to a yaw encoder, which provides angular position of the bedplate with respect to the stationary tower. A wind vane, which can be attached to the bedplate, is connected to a wind vane encoder. The yaw encoder and wind vane encoder send data to a turbine controller. When the bedplate orientation differs from the average wind direction by a predetermined amount, a yaw brake that keeps the bedplate in place is released in a controllable fashion, such that some amount of friction between the brake pads and the stationary disk remains. Consequently, the bedplate will controllably rotate to align itself with the newly established average wind vector, thus aligning the turbine blade rotation plane substantially perpendicularly against the average wind vector. When the bedplate arrives to its new position, as determined by the yaw encoder reading, the yaw brake can be fully applied again to fix the bedplate at its new position. The details of the exemplary embodiments of the present invention are explained with reference to FIGS. 1-4.

FIG. 1 shows a schematic view illustrating the subsystems of a downwind turbine 10. Turbine blades 104 spin due to the wind momentum, thus providing mechanical torque to an electrical generator 105, which, in turn, produces electrical energy. In order to maximize the power output of the turbine, wind direction should be perpendicular to the plane of rotation of the turbine blades 104. Wind direction can be detected by wind vane 100. Many types of wind vanes are available on the market, and would be known to a person skilled in the art. An example of widely available wind vane is Black Max Windvane from West Marine in Watsonville, Calif. The turbine 10 can also have an anemometer 102 to provide wind speed information. The inventor has found that anemometer NRG #40H made by NRG Systems, Inc., Hinesburg, Vt. works well. The generator 105, turbine blades 104, wind vane 100, anemometer 102, and other equipment can be installed on a bedplate 106, which is mounted over support column 108 having a center axis 101. The support column 108 is further pivotably mounted on a slew bearing 116, which is also centered about center axis 101. Therefore, as the bedplate 106 and support column 108 pivot about center axis 101, the turbine blades 104 change their angle with respect to the incoming wind direction. As explained above, if allowed to pivot freely, the bedplate will keep orienting itself such that the incoming wind blows roughly into the plane of rotation of the turbine blades 104; however such pivoting would be done in an uncontrolled and potentially damaging fashion.

Still referring to FIG. 1, a yaw brake 112 is attached to brake mounting plate 110, which is in turn attached with support column 108. Therefore, the yaw brake 112 rotates with bedplate 106 and support column 108. The yaw brake is capable of engaging with a stationary brake disc 114, which is mounted to the slew bearing 116 and is fixed to a tower adapter 120. A lattice tower 122 secures the tower adapter and the rest of the wind turbine structure to the ground. When fully engaged with the stationary brake disc, the yaw brake prevents pivoting of the support column 108 and the bedplate 106 about center axis 101, thus fixing the plane of rotation of the turbine blades 104.

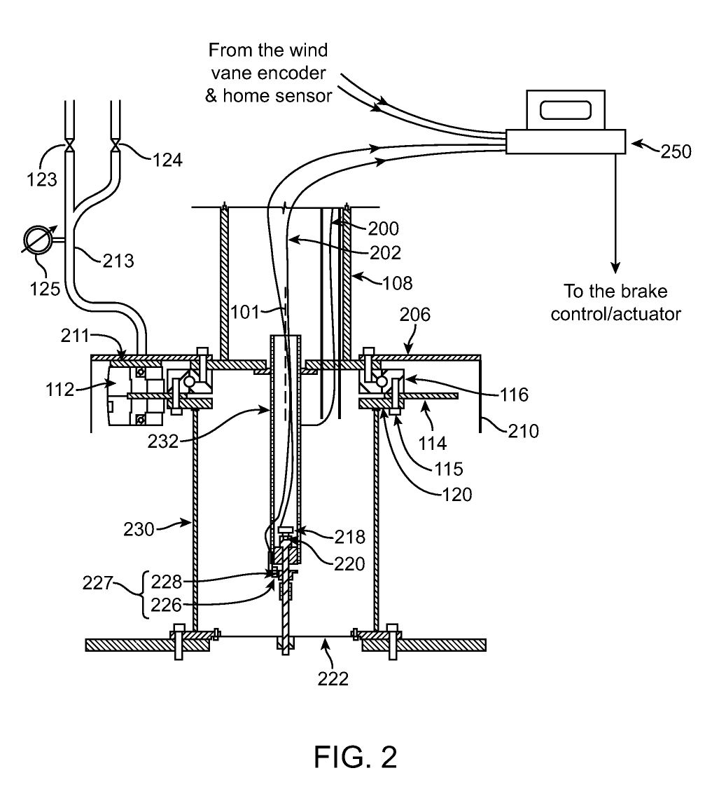

FIG. 2 shows the elevation cross-sectional view illustrating a part of yaw control mechanism. In this embodiment, a set of fasteners 115 connects the tower adapter 120 with stationary brake disc 114 and the outer race of the slew bearing 116, but other means of connection or clamping are also possible. The parts attached with the tower adapter 120 are stationary. Conversely, the parts attached with the inner race of the slew bearing 116 can rotate about center axis 101 when the yaw brake 112 is not fully engaged with the stationary brake disc 114.

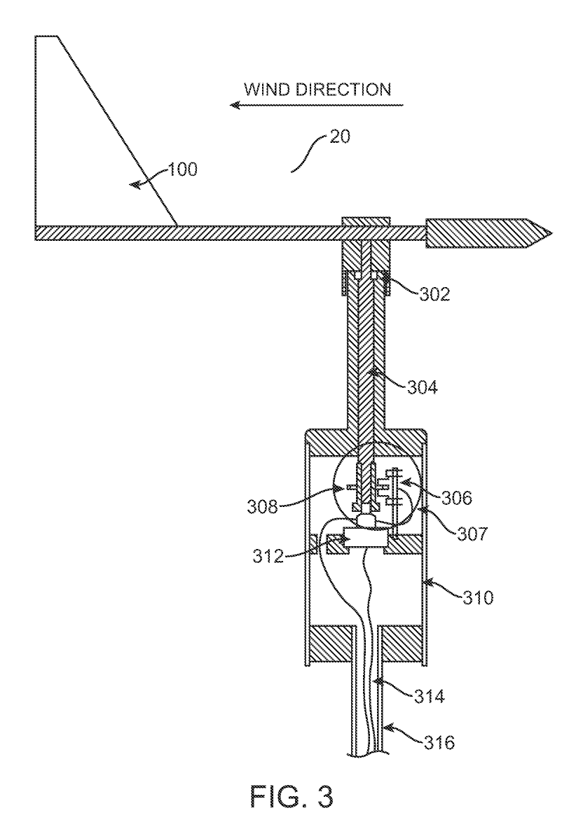

Still referring to FIG. 2, fluid pressure to the yaw brake can be controlled through the pressure valve 123 and return valve 124. Opening the pressure valve increases the pressure of hydraulic fluid to the yaw brake, thus increasing the braking force. Opening the return valve decreases the hydraulic fluid pressure, thus reducing the braking force. Hydraulic fluid pressure can be measured by a pressure transducer 125, and a pressure signal can be sent to a turbine controller 250, which can be a dedicated board, a general purpose computer, an industrial controller, an A/D board, a D/A board, or a combination thereof. The yaw brake is attached to a shim 211, and further to the inner racer of the slew bearing, thus making possible rotation of the yaw brake about center axis 101. A sensor housing 230 provides a weather proofing, while removable cover plate 222 provides access to the yaw home position sensor 227 and yaw encoder 218. The yaw home position sensor 227 is configured to provide a signal when rotating support column 108 arrives to a predetermined angular position with respect to the non-rotating parts, thus signaling a home position of the turbine. Yaw home position sensor 227 has a stationary vane 226 attached to a stationary stem 220, which is further attached to the cover plate 222. A rotating stem 228 is attached to a rotating yaw tube 232. When the rotation of the rotating yaw tube 232 brings the rotating stem 228 to the position opposite from the stationary vane 226, a home position signal is generated and sent to the turbine controller 250. Many home position sensors are available on the market, and would be known to a person skilled in the art. An example of a home position sensor is SR13C-A1 Sensor Magn SS Hall Effect by Honeywell Sensing and Control company. Relative angular position of the rotating support column 108 with respect to the non-rotating tower adapter 120 and stationary brake disc 114 can be sensed by a yaw encoder 218, which may be an optical encoder. Rotary portion of the yaw encoder 218 rotates with the rotating yaw tube 232 while a stationary shaft of the yaw encoder is attached to the stationary stem 220. Therefore, as the rotating yaw tube 232 spins around center axis 101, the yaw encoder 218 indicates the yaw angle of the turbine. Many angle encoders are available on the market, an example is Optical Rotary Vertical Encoder 600128C24 from Honeywell Sensing and Control company. Yaw angle can also be sensed by a yaw sensor which can indicate both the yaw angle and home position. Such yaw sensor can be used in place of the yaw encoder 218 and yaw home position sensor 227 combination. An example of such yaw sensor is an absolute magnetic encoder model MA3-P10-125B made by US Digital. Other yaw sensors are widely available on the market, and would be known to a person skilled in the art. The turbine controller 250 receives the yaw angle signal from the yaw encoder 218. The turbine controller is furthermore capable of issuing control signal to the brake hydraulic system located on the turbine bedplate 106. This control signal is based in part on the yaw angle and home position of the turbine, and also in part on the wind direction and speed signal coming from the wind vane, as described in reference to FIG. 3 below.

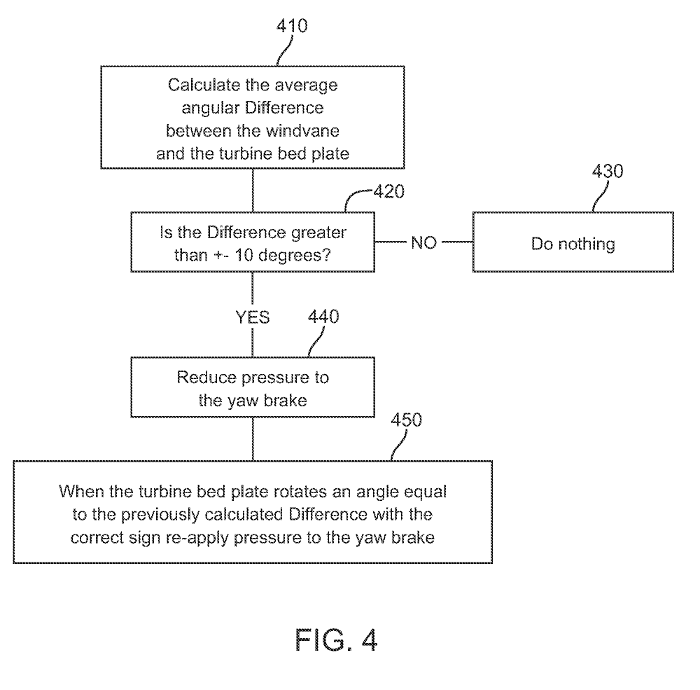

FIG. 3 shows a cross-sectional view of a wind vane in accordance with one embodiment of the invention. The wind vane 100 is fixedly mounted on a wind vane stem 304, which, in turn, is engaged with one race of a top bearing 302. The other race of the top bearing 302 is engaged with the stationary part of a wind direction detection mechanism 20, which can be attached to the bedplate 106 (not shown) or other suitable part of the wind turbine. Therefore, orientation of the wind vane stem 304 indicates the direction of the wind. A wind vane home position sensor 307 and a wind vane encoder 312 indicate a home position of the wind vane stem 304 as described below. The wind vane home position sensor 307 has a wind vane optical sensor 306 (stationary) and a single slit optical vane 308 (follows rotation of the wind vane stem 304). When the slit of the vane 308 passes the window of optical vane sensor 306, a signal is generated and sent to the turbine controller. This signal corresponds to wind vane's home position, which can be chosen such that it signifies that the wind vane and the bedplate axis are in alignment, i.e. the wind direction is perpendicular to the turbine blade rotation plane. However, other choices of the wind vane's home position can also be made. Relative angle of the wind vane with respect to the bedplate axis can be indicated as follows. A wind vane encoder can have its rotary part attached to the wind vane stem 304, and its stationary part attached with a wind vane housing 310. As the wind vane stem 304 rotates, the wind vane encoder 312 generates a fixed number of pulses per revolution. These pulses are sent to the turbine controller which determines the position of wind vane 100 relative to the bedplate. The number of pulses generated by the wind vane encoder 312 per full revolution determines the angular resolution. The inventor has found that a 256 pulse encoder, having a resolution of 360°/256 or 1.4°, works well. Based on the signals from the yaw encoder, yaw home position sensor, wind vane home position sensor, wind vane encoder, and the anemometer, the turbine controller regulates and controls the wind turbine yaw angle as described below in reference to FIG. 4.

FIG. 4 shows a flow diagram illustrating the steps of the yaw angle control method. In this embodiment, in step 410 the average angular difference between the wind vane and the bedplate is calculated. The wind vane angle is representative of the wind direction. The bedplate position is representative of the turbine blade rotation plane. Under variable winds, the wind vane will be in constant motion and the turbine controller must calculate average wind direction to avoid constant small adjustments. Therefore, the average angular difference between the wind vane and the bedplate is used. The inventor has found that the averaging over several minutes works well.

In step 420, a comparison is made between the average angular position of the wind vane and the position of the bedplate. If the difference is below a deadband value, the process continues to step 430. No action is taken, and the moving average of the wind direction continues to be calculated in step 410. By using the deadband, the controller avoids adjusting the turbine's yaw angle for small misalignments between the average wind direction and the turbine blade rotation plane. The inventor has found that the 10° deadband works well. If the difference between the average angular position of the wind vane and the position of the bedplate is greater than the deadband value, the process continues to the step 440.

In step 440, hydraulic fluid pressure to the yaw brake is reduced, which allows the bedplate to turn into the wind, thus repositioning the turbine blade rotation plane perpendicularly to the average wind direction. Opening the return valve allows metered flow back to the hydraulic system, thus reducing the yaw brake pressure, which, in turn, permits the bedplate to be dragged about tower axis 101 in a controlled manner, avoiding potentially damaging sudden rotations of the wind turbine. A pressure transducer on the brake hydraulic line can be used to determine pressure between the yaw brake pads and the stationary brake disc. The pressure transducer reading can be used to adjust the pressure valve and return valve, thus assuring well controlled rotation of the bedplate.

In step 450, as the bedplate rotates, the yaw encoder also rotates and feeds its signal to the turbine controller, which determines whether the desired orientation of the bedplate has been achieved yet. When the bedplate arrives to the desired new position, the turbine controller sends a signal to the hydraulic system to increase the pressure thus fully engaging the yaw brake, and arresting the bedplate rotation. The turbine blade rotation plane is now substantially perpendicular to the average wind direction, and the process can be repeated starting from step 410.

Many variations of the process described in FIG. 4 are possible. For example, anemometer wind speed reading can be used to further control the pressure at the yaw brake. It may be undesirable to fully release the yaw brake when the average wind speed is above certain threshold, for example 15 mph. Therefore, at high wind speeds, the yaw brake pressure may be reduced to a value which will still permit the bedplate to yaw, but with a dampened response, thus preventing the undesirable high yaw rates. The inventor has found that the exact target pressure of the yaw brake is dependent upon many factors, and is best determined experimentally for each turbine design. Furthermore, a person skilled in the art will understand that the invention embodiments without the yaw home position sensor are possible, as the process described with reference to FIG. 4 does not necessarily have to use the home position of the bedplate.

As will be understood by those skilled in the art, the present invention may be embodied in other specific forms without departing from the essential characteristics thereof. For example, a single rotary encoder can provide both the home position and the angle of rotation. This single rotary encoder can be used in place of the home position sensor and encoder pair. Furthermore, electrical, pneumatic, or mechanical yaw brakes can be used in place of hydraulic yaw brake. The lattice tower can be replaced by a tube tower. Many other embodiments are possible without deviating from the spirit and scope of the invention. These other embodiments are intended to be included within the scope of the present invention, which is set forth in the following claims.

What is claimed is:

1. An apparatus for controlling the orientation of a wind turbine, comprising:
a stationary brake disc;
a yaw brake attached with a bedplate of the wind turbine, said yaw brake capable of frictionally engaging the stationary brake disc in response to a control signal thus fixing a position of the bedplate with respect to the stationary brake disc;
a wind vane, said wind vane capable of indicating a wind direction;
a wind vane encoder attached with the wind vane and configured to indicate a rotational position of the wind vane, thus indicating the wind direction;
a yaw encoder configured to indicate a rotational position of the bedplate with respect to the brake disc, thus indicating orientation of a turbine blade rotation plane with respect to the stationary brake disc;
a turbine controller capable of receiving information from the wind vane direction sensor and the yaw sensor, said turbine controller configured to:
calculate a relative difference between the rotational positions of the wind vane and the bedplate, and
generate a brake control signal, thus causing the yaw brake to engage and disengage.

2. The apparatus of claim 1, wherein said wind vane is attached with the bedplate.

3. The apparatus of claim 1, further comprising a wind vane home position sensor, said sensor configured to provide a home position of the wind vane with respect to the bedplate or the stationary brake disc.

4. The apparatus of claim 1, further comprising a yaw home position sensor, said sensor configured to provide a home position of the bedplate with respect to the stationary brake disc.

5. The apparatus of claim 1, wherein said brake control signal is generated to release the yaw brake when the relative difference between the rotational positions of the wind vane and the bedplate is higher than about +/−10°.

6. The apparatus of claim 5, wherein said brake control signal is generated based on a time averaged rotational position of the wind vane.

7. The apparatus of claim 1, further comprising an anemometer configured to send a wind speed signal to said turbine controller, wherein said brake control signal is based at least in part on the wind speed signal, thus preventing unsafe yaw brake release at high wind.

8. The apparatus of claim 7, further comprising a pressure transducer configured to:
measure pressure in a brake hydraulic line, thus measuring pressure exerted by the yaw brake to the stationary brake disc, and
make pressure measurements available to the control system, thus preventing uncontrolled rotation of said yaw brake about said stationary brake disc.

9. The apparatus of claim 7, further comprising:
a pressure valve, said pressure valve configured to increase fluid pressure to said yaw brake when opened, thus increasing a breaking force; and
a return valve, said return valve configured to decrease fluid pressure to said yaw brake when opened, thus decreasing the breaking force.

10. The apparatus of claim 1 wherein said turbine controller is chosen from a group consisting of a general purpose computer, an industrial controller, an A/D board, a D/A board, or a combination thereof.

11. The apparatus of claim 1, wherein said yaw brake is chosen from a group consisting of a hydraulic brake, a pneumatic brake, an electrical brake, or a combination thereof.

12. A method for controlling the orientation of a wind turbine, comprising:
receiving a wind direction data based on a wind vane position;
receiving a bedplate orientation data with respect to a stationary brake disc;
determining whether a difference between the bedplate orientation and the wind direction is higher than a threshold;
releasing a yaw brake that holds the bedplate fixedly with the stationary brake disc, thus enabling the bedplate to change its position with respect to the stationary brake disc; and
applying the yaw brake when the bedplate and the wind direction is lower than a threshold.

13. The method of claim 12, wherein said applying the yaw brake is done if the bedplate orientation and the wind direction substantially coincide.

14. The method of claim 12, wherein said threshold is about +/−10°.

15. The method of claim 12, wherein said releasing of the yaw brake is done at least in part based on a wind speed signal, thus preventing unsafe yaw brake release at high wind.

16. The method of claim 15, wherein said releasing the yaw brake is done such that the yaw brake slows down bedplate rotation at high wind.

17. The method of claim 16, wherein said releasing the yaw brake is done at least in part based on a pressure transducer signal.

18. The method of claim 12, wherein said wind direction data is time averaged.

19. The method of claim 18, wherein said time averaging is performed over one or more minutes.
